(19) United States
(12) Patent Application Publication
(10) Pub. No.: US 2014/0121990 A1
(43) Pub. Date: May 1, 2014

(54) Secure Informatics Infrastructure for Genomic-Enabled Medicine, Social, and Other Applications

(71) Applicant: THE REGENTS OF THE UNIVERSITY OF CALIFORNIA, (US)

(72) Inventors: Pierre Baldi, Irvine, CA (US); Gene Tsudik, Irvine, CA (US)

(73) Assignee: THE REGENTS OF THE UNIVERSITY OF CALIFORNIA, Oakland, CA (US)

(21) Appl. No.: 13/835,682

(22) Filed: Mar. 15, 2013

Related U.S. Application Data
(60) Provisional application No. 61/700,011, filed on Sep. 12, 2012.

(51) Int. Cl. G06F 19/22

(52) U.S. Cl. CPC G06F 19/22
USPC 702/20

(57) ABSTRACT

A system is disclosed in which human genomes are stored in databases or in a cloud based computer system, which is secure and private and then downloaded to personal devices for possible peer-to-peer interactions for health care applications, as well as for social and other applications. The use of the system is directed to fully sequenced genomes and includes protocols that are constructed to mimic in vitro biological tests to conduct genomic analysis instead of generic computational techniques, which tend to be impractical as they require performance of online computation over the entire genome. Three specific examples of protocols or techniques for privacy-preserving testing on fully sequenced genomes included are: 1) privacy-preserving genetic paternity testing, 2) privacy-preserving personalized medicine testing, and 3) privacy-preserving genetic compatibility testing.

### RELATED APPLICATIONS

The present application is related to U.S. Provisional Patent Application Ser. No. 61/700,011 filed on Sep. 12, 2012, which is incorporated herein by reference and to which priority is claimed pursuant to 35 USC 120.

### GOVERNMENT RIGHTS

This invention was made with government support under Grant Nos. LM007443 and LM010235 awarded by National Institutes of Health. The government has certain rights in the invention.

### BACKGROUND

1. Field of the Technology

The disclosure relates to the field of informatics infrastructures, specifically a secure informatics infrastructure for use in genome-enabled medicine, social, and other applications.

2. Description of the Prior Art

The cost of sequencing an individual human genome is decreasing exponentially. It is about $1000 today and will soon be less than an MRI scan or other standard medical procedure.

Recent advances in DNA sequencing technologies have put ubiquitous availability of fully sequenced human genomes within reach. It is no longer hard to imagine the day when everyone will have the means to obtain and store one's own DNA sequence.

Widespread and affordable availability of fully sequenced genomes immediately opens up important opportunities in a number of health related fields. In particular, common genomic applications and tests performed in vitro today will soon be conducted computationally, using digitized genomes. New applications will be developed as genome-enabled medicine becomes increasingly preventive and personalized. However, this progress also prompts significant privacy challenges associated with potential loss, theft, or misuse of genomic data. Using the illustrated embodiment of the invention, we begin to address genomic privacy by focusing on three important applications: Paternity Tests, Personalized Medicine, and Genetic Compatibility Tests. After carefully analyzing these applications and their privacy requirements, we propose a set of efficient techniques based on private set operations. This allows us to implement in in silica some operations that are currently performed via in vitro methods, in a secure fashion. Experimental results demonstrate that proposed techniques are both feasible and practical today.

Over the past four decades, DNA sequencing has been one of the major driving forces in life-sciences, producing full genome sequences of thousands of viruses and bacteria, and dozens of eukaryotic organisms, from yeast to man. This trend is only being accentuated by modern High-Throughput Sequencing (HTS) technologies: the first diploid human genome sequences were recently produced and a project to sequence 1,000 human genomes has been essentially completed. Different HTS technologies are competing to sequence an individual human genome—composed of about 3 billion DNA nucleotides (or bases)—for less than $1,000 by 2012, and even less than $100 five years later, reaching the point where human genome sequencing will be a commodity costing less than an X-ray or an MRI scan. Ubiquity of human and other genomes creates enormous opportunities and challenges. In particular, it promises to address one of the greatest societal challenges of our time: the unsustainable rise of health care costs, by ushering a new era of genome-enabled predictive, preventive, participatory, and personalized medicine (“P4” medicine). In time, genomes could become part of the Electronic Medical Record of every individual.

However, widespread availability of HTS technologies and genomic data exacerbates ethical, security, and privacy concerns. A full genome sequence not only uniquely identifies each one of us—it also contains information about, for instance, our ethnic heritage, disease predispositions, and many other phenotypic traits. Traditional approaches to privacy, such as de-identification, become completely moot in the genomic era, since the genome itself is the ultimate identifier. To further compound the privacy problem, health information is increasingly shared electronically among insurance companies, health care providers, and employers. This, coupled with the possibility of creating large centralized genome repositories, raises the specter of possible abuses.

Some federal laws have been passed to begin addressing privacy issues. The 2003 Health Insurance Portability and Accountability Act (HIPAA) provides a general framework for protecting and sharing Protected Health Information (PHI). In 2008, the Genetic Information Nondiscrimination Act (GINA) was adopted to prohibit discrimination on the basis of genetic information, with respect to health insurance and employment. While providing general guidelines and a basic safety net, current legislation does not offer detailed technical information about safe and privacy preserving ways for storing and querying genomes. In short, technical issues of security and privacy for HTS and genomic data remain both important and relatively poorly understood.

While privacy issues are not yet hampering progress in basic genomic research, it is not too early to start investigating them, particularly, in light of their complexity, potential impact on society, and current efforts to reform the health care system. It remains unclear where personal genomic information will be stored, who will have access to it, and how it will be queried and shared. To remain flexible, we can imagine a general framework comprised of two kinds of basic entities: (1) Data Centers where genomic data is stored, and (2) Agents/Agencies interested in querying this data. Granularity of Data Centers could vary. At one end of the spectrum, every individual could be her own Data Center and store the genome on a personal computer, cell phone, or some other device.

At the other extreme, we could envision national or even international Data Centers storing millions (or even billions) of genomic sequences. Data Centers could also be envisioned at the granularity of family, school, pharmacy, laboratory, hospital, city, county or state. Likewise, many different types of Agents/Agencies are conceivable, ranging from individuals and personal physicians, to family members, pharmacies, hospitals, insurance companies, employers and government agencies (e.g., the FBI), or international organizations. Various Agents/Agencies might be allowed to query different aspects of genomic data and might be required to satisfy different query privacy requirements. In addition, one could imagine cases (e.g., criminal search or proprietary diagnostic technology) where both the genomic data and queries against it must remain private.

Motivated by the sensitivity of genomic information, the security research community has begun to develop mechanisms to enable secure computation on genomic data. A number of cryptographic protocols have been proposed for private searching, matching and evaluating similarity of strings, including DNA sequences, Also, prior work has considered specific (privacy-preserving) genomic operations. This section overviews relevant prior results and highlights their potential limitation.

### Searching and Matching DNA

Troncoso-Pastoriza, et al. proposed a privacy-preserving and error-resilient protocol for string searching. In it, one party (e.g., Alice), with her own DNA snippet, can verify the existence of a short template (e.g., a genetic test held by a service provider, Bob) within her snippet. This technique handles errors and maintains privacy of both the template and the snippet. Each query is represented as an automaton executed using a finite state machine (FSM) in an oblivious manner. Communication complexity is O(n·(|Σ|+|Q|)), where n is snippet length, |Σ| is the alphabet size (i.e., 4 for DNA), and |Q| is the number of states. Computational complexity is O(n·|Σ|·|Q|) and O(n·|Q|) cryptographic operations for Alice and Bob, respectively. However, the number of FSM states is always revealed to all parties. To obtain error-resilient and approximate DNA matching, it also shows how to construct an automaton that, given Alice's string x, accepts all strings with Levenshtein distance at most d from x.

Blanton and Aliasgari improve on previous methods by reducing Alice's work by a factor of |Σ| and Bob's by a factor of log(|Q|), incurring, however, a potentially increased communication complexity (if the security parameter is smaller than log(|Q|)). This work also introduces a protocol for secure outsourcing of computation to an external service provider and a modified multi-party protocol.

A set of cryptographic protocols for secure pattern matching have also been previous used. Given a binary string T of length n, held by Alice, and a binary pattern p of length m, held by Bob, pattern matching lets Bob learn all locations in T where p appears.

Secure computation guarantees that nothing except m is learned by Alice, and nothing about T is revealed to Bob (besides n and locations where p appears). The prior art proposes one such protocol, secure in the semi-honest setting, based on homomorphic encryption, with O(m+n) communication and computation complexities. It includes another protocol, secure in the malicious setting, based on secure oblivious automata evaluation, with quadratic complexity and m rounds. Subsequently, other prior art methods have presented an improved protocol, with malicious security, using homomorphic encryption and incurring O(m+n) complexity.

Another related attempt realizes secure computation of the CODIS test (run by the FBI for DNA identity testing), that could not be implemented using pattern matching or FSM. It achieves efficient secure computation of function M(T,p,e,I)=1 iff IIₘₐₓ(T,p)−II≦ε, where T is a DNA fragment, p a pattern, (ε, I) some additional information, and Iₘₐₓ(T,p)≧0 is the largest integer I′ for which p^{I}′ appears as a substring in T. A general technique for secure text processing is introduced, combining garbled circuits and secure pattern matching. (The latter is reduced to private keyword search and solved using Oblivious Pseudorandom Functions (OPRF-s)) The resulting protocol can compute several functions (including CODIS) on sample T and pattern p, using the number of circuits linear in the number of occurrences of p. Complexity incurred by the underlying keyword search protocol is linear in |T|. However, common knowledge of some threshold on the number of occurrences needs to be assumed.

Another set of cryptographic results focus on privately computing the edit distance of two strings α, β of size m and n, respectively. Privacy-preserving computation of Smith-Waterman scores has also been investigated and used for sequence alignment.

Jha, et al. proposes techniques for secure edit distance using garbled circuits, and showed that the overhead is acceptable only for small strings (e.g., a 200-character strings require 2 GB circuits). For longer strings, two optimized techniques were proposed; they exploit the structure of the dynamic programming problem (intrinsic to the specific circuit) and split the computation into smaller component circuits. However, a quadratic number of oblivious transfers is needed to evaluate garbled circuits, thus limiting scalability of this approach. For example, 500-character string instances take almost one hour to complete. Optimized protocols also extend to privacy-preserving Smith-Waterman scores, a more sophisticated string comparison algorithm, where costs of delete/insert/replace operations, instead of being equal, are determined by special functions. Again, scalability is limited: experiments have shown that evaluation of Smith-Waterman for a 60-character string takes about 1,000 seconds.

Somewhat less related techniques include proposing a cryptographic framework for executing queries on genomic databases where privacy is attained by relying on two anonymizing and non-colluding parties. Danezis, et al. used negative databases to test a single profile against a database of suspects, such that database contents cannot be efficiently enumerated.

Wang, et al. has proposed techniques for computation on genomic data stored at a data provider, including: edit distance, Smith-Waterman and search for homologous genes. Program specialization is used to partition genomic data into “public” (most of the genome) and “sensitive” (a very small subset of the genome). Sensitive regions are replaced with symbols by data providers (DPs) before data consumers (DCs) have access to genomic information. DCs perform concrete execution on public data and symbolic execution on sensitive data, and may perform queries to DPs on sensitive nucleotides. However, only queries that do not let DCs reconstruct sensitive regions are allowed by DPs and generic two-party computation techniques are used during query execution. Portions of sensitive data are public information. We note that, due to the current limited knowledge of the human genome, parts that are considered non-sensitive today may actually become sensitive later.

Finally, Bruekers, et al. presented privacy-preserving techniques for a few DNA operations, such as: identity test, common ancestor and paternity test, based on STR (Short Tandem Repeat). Homomorphic encryption is used on alleles (fragments of DNA) to compute comparisons. Testing protocols to locate a small number of errors, however, their complexity increases with the number of tolerated errors. Also, this option leaves as an open problem the scenario where an attacker (honestly) runs the protocol but executes it on arbitrarily chosen inputs. In this setting, attackers, given STR's limited entropy, can “lie” about their STR profiles and run multiple dependent protocols thus reconstructing the other party's profile.

Prior work has yielded a number of elegant (if not always efficient) cryptographic protocols for secure computation on DNA sequences. However, the prior art also fails to solve some notable open problems:
a. 1. Efficiency: Most current protocols are designed for DNA snippets (e.g., hundreds of thousands nucleotides) and it is unclear how to scale them to full genomes (i.e., three billion nucleotides).
b. 2. Error Resilience: Most prior work attempts to achieve resilience to sequencing errors in computation (e.g., using approximate matching or distance with errors). Not surprisingly, this results in: (i) significant computation and communication overhead, and (ii) ruling out more efficient and simpler cryptographic tools, i.e., those geared for exact matching. Also, as the cost of full genome sequencing drops, so do error rates. By increasing the number of sequencing runs, the probability of sequencing errors can be rapidly reduced.
c. 3. Inter-String Distance: Analyzing the distance between sequenced strings works for the creation of phylogenetic trees, parental analysis, and homology studies. However, it does not suit other applications, such as genetic diseases testing, that require much more complex comparisons.
d. 4. Paternity Testing: To the best of our knowledge, the only available technique for privacy-preserving genetic paternity testing does not prevent a participant from manipulating its input to reconstruct the counterpart's profile. Also, as shown further below, overhead can be significantly reduced using techniques that obtain error resilience by design.
e. 5. Genetic Testing via Pattern Matching: The use of pattern matching over full genomes to test for genetic compatibility and/or personalized medicine is not straightforward. Suppose that a party wants to privately search for certain gene mutation, e.g., Beta-Thalassemia. The pattern representing this mutation might be very short—a few nucleotides—but needs to be searched in the full genome, as restricting the search to the specific gene would trivially expose the nature of the test. Therefore, naive application of pattern matching would return all locations (presumably millions) where the pattern appears. This would be detrimental to both privacy and efficiency of the resulting solution. The pattern needs to be modified to include nucleotides expected to appear immediately before/after the mutation, such that, with high probability, this pattern would appear at most once. However, this needs to be done carefully, since: (i) nucleotides added to the pattern must appear in all human genomes, and (ii) the choice of pattern length should not expose the mutation being searched. Plus, extending the pattern would also increase computation and communication overhead.

What is needed therefore is an apparatus and method for performing in depth analysis of the human genome which addresses the problems left open by the prior art. The main security and privacy challenge is how to support such queries with low storage costs and reasonably short query times, while satisfying privacy and security requirements associated with a given type of transaction. Unfortunately, current methods for privacy-preserving data querying do not scale to genomic data sizes. Several cryptographic techniques have been proposed that, though not addressing the case of fully-sequenced genomes, focus on private computation over genomic fragments. Specifically, they allow two or more parties to engage in protocols that reveal only the end-result of a given computation on their respective genomic data, without leaking any additional information. The main thrust of the illustrated embodiment of the invention is the adaption and deployment of efficient cryptographic techniques used to address specific genomic queries and applications, described below. Currently, there are no ways of storing human genomes for the use in digital applications, only via analog “in vitro” processes.

### BRIEF SUMMARY

We have designed an infrastructure or system where human genomes can be stored in databases or in a cloud based computer infrastructure which are secure and private and then downloaded to personal devices for possible peer-to-peer interactions for health care applications, as well as for social and other applications. Furthermore, genomes can be downloaded to personal devices, such as smart phones (e.g. iPhones) in a secure and private way. Using these devices, a user can interact with points of health care ranging from hospitals (e.g. emergency rooms), to personal physicians and pharmacies. In addition, we have devised methods by which private and secure transactions could occur in peer-to-peer fashion between such devices. These transactions could be used in a variety of applications beyond medical applications, and in particular in social applications. Examples of other transactions include: (1) paternity tests; (2) relatedness tests (i.e., how long ago did our most recent common ancestor live); (3) distance and similarity (i.e., how similar are our genomes to one another); and (4) genetic tests or other kinds of compatibility tests. Finally, genomic similarity could be used in a variety of applications, in particular, those based on social networks. For instance, edges in Facebook could be weighed by genomic similarity. Delivery of education could be based on genomic information. Creation of teams or groups (for example in education, in the workplace, in sports teams, and in the military) could be based on or informed by genomic information.

The illustrated embodiments are based on well-known cryptographic tools including Private Set Intersection (PSI), Private Set Intersection Cardinality (PSI-CA), and Authorized Private Set Intersection (APSI). Each of the tools are software controlled computer procedures or algorithms. However unlike previous work, it is directed to fully sequenced genomes and includes protocols that are constructed to mimic in vitro biological tests to conduct genomic analysis instead of generic computational techniques, which tend to be impractical as they require performance of online computation over the entire genome. Three specific examples of protocols or techniques for privacy-preserving testing on fully sequenced genomes is provided below. These protocols include: 1) Privacy-Preserving Genetic Paternity Testing (PPGPT), 2) Privacy-preserving personalized medicine testing (PPPMT or P³MT), and 3) Privacy-Preserving Genetic Compatibility Testing (PPGCT).

As mentioned above, availability of affordable full genome sequencing makes it increasingly possible to query and test genomic information not only in vitro, but also in silica using computational techniques. We consider three concrete examples of such tests and corresponding privacy-relevant scenarios.

Paternity Tests establish whether a male individual is the biological father of another individual, using genetic fingerprinting. In this technique, the genomes of 2 parties are compared to determine if there is a paternity match by checking to see if the genomes match significantly higher than 99.5%. However, instead of using generic computational techniques to analyze a digitally sequenced genome, the illustrated embodiment of the invention utilizes the in vitro techniques of RFLP or SNP to reduce the amount of data to be analyzed and to share different data to determine whether there is a match. Unlike prior work, the illustrated embodiment of the invention is applicable to fully sequenced genomes and mimics in vitro analysis techniques of the fully sequenced genome.

Advances in biotechnology have facilitated DNA paternity tests and stimulated the creation of hundreds of online companies offering testing via self-administered cheek swabs for as little as $79 (e.g., http://www.gtldna.net). However, this practice raises several security and privacy concerns: the testing company must be trusted with privacy and accuracy of test results, as well as with swabs that might yield full genome sequencing. We believe that, ideally, any two individuals, in possession of their genomes should be able to conduct a privacy-preserving paternity test with no involvement of any third parties. Only the outcome of the test ought to be learned by one or both parties and no other sensitive genomic information should be disclosed.

Personalized Medicine is recognized as a significant paradigm shift and a major trend in health care, moving us closer to a more precise, powerful, and holistic type of medicine. In this technique, the genome of a patient is compared with a DNA fingerprint of a drug to determine if the patient is compatible with the drug. The technique uses reference-based compression to determine the differences between the patient's genome and a reference genome to reduce the amount of data to be analyzed. The DNA fingerprint of the drug is then compared to the differences between the patient's genome and a reference genome using APSI cryptographic technique with fingerprint authorization. Unlike prior work, the DNA fingerprint is compared to the entire genome and not just DNA snippets, and enforces fingerprint authorization by a trusted entity such as the FDA.

With personalized medicine, treatment and medication type/dosage would be tailored to the precise genetic makeup of individual patient. For example, measurements of erbB2 protein in breast, lung, or colorectal cancer patients are taken before selecting proper treatment. It has been showed that the trastuzumab monoclonal antibody is effective only in patients whose genetic receptor is over-expressed. Furthermore, the FDA has recently recommended testing for the thiopurine S-methyltransferase (tpmt) gene, prior to prescribing for 6-mercaptopurine and azathioprine—two drugs used for treating childhood leukemia and autoimmune diseases. The tpmt gene codes for the TPMT enzyme that metabolizes thiopurine drugs: genetic polymorphisms affecting enzymatic activity are correlated with variations in sensitivity and toxicity response to such drugs. Patients suffering from this genetic disease (1 in 300) only need 6-10% of the standard dose of thiopurine drugs; if treated with the full dose, they risk severe bone marrow suppression and subsequent death. Not surprisingly, experts predict that availability of full genome sequencing will further stimulate development of personalized medicine.

Genetic Tests are routinely used for several purposes, such as newborn screening, confirmational diagnostics, as well as pre-symptomatic testing, e.g., predicting Huntington's disease and estimating risks of various types of cancer. In this technique, a fingerprint of a genetic disease corresponding to one party is compared to the fully sequenced genome of another party to determine compatibility of the parties with regard to genetic diseases utilizing a private set instruction cryptographic technique. The illustrated embodiments focus on genetic compatibility tests, whereby potential or existing partners wish to assess the possibility of transmitting to their children a genetic disease with Mendelian inheritance. Modern genetic testing can accurately predict whether a couple is at risk of conceiving a child with an autosomal recessive disease. Consider, for instance, Beta Thalassemia minor, that causes red cells to be smaller than average, due to a mutation in the hbb gene. It is called minor when the mutation occurs only in one allele. This minor form has no severe impact on a subject's quality of life. However, the major variant that occurs when both alleles carry the mutation is likely to result in premature death, usually, before age twenty. Therefore, if both partners silently carry the minor form, there is a 25% chance that their child could carry the major variety. Another example is the Lynch Syndrome (also known as Hereditary Nonpolyposis Colon Cancer), a genetic condition, most commonly inherited from a parent, associated with the high risk of colon cancer. Parents with this syndrome have a 50% chance of passing it on to their children. Since the possibility of inheritance is maximized if both parents carry the mutations, testing for Lynch Syndrome is crucial.

Note on Non-human Genomes: Although the illustrated embodiments focus on human genomes, it is to be expressly understood that the embodiments can applied to other organisms, e.g., crops and animals. For instance, a paternity test may certify a purebred dog's bloodline or genetic tests may determine the quality of a racing horse. In fact, DNA “barcodes” identifiers are already embedded in genomes of genetically modified species. Conceivably, future veterinary treatments may also involve elements of personalized medicine for animals.

Motivated by the emerging affordability of full genome sequencing, the illustrated embodiment of the invention combines domain knowledge in biology, genomics, bioinformatics, security, privacy and applied cryptography in order to better understand the corresponding security and privacy challenges. In particular, we analyze specific requirements of three types of applications discussed above: Paternity Tests, Personalized Medicine and Genetic Tests. In the process, we carefully consider today's in vitro procedure for each application and analyze its security and privacy requirements in the digital domain. This type of approach allows us to gradually craft specialized protocols that incur appreciably lower overhead than the state-of-the-art. However, as is well known, “lower overhead” does not necessarily imply practicality. Therefore, we demonstrate, via experiments on commodity hardware that proposed protocols are indeed viable and practical today. Source code of our implementations is publicly available. We hope that it can help in developing privacy-aware operations on full genomes and allows individuals (in possession of their sequenced genomes) to run genetic tests with privacy.

More specifically, the illustrated embodiments of the invention include a method for performing privacy-preserving genetic paternity testing in silico over the full genome between a first input source (Client) and a second input source (Server). The method includes the steps of inputting respective digitized genomes into the first input (Client) and second input (Server), performing a restriction fragment length polymorphism procedure (RFLP) based protocol on a common input of a threshold τ, on a plurality of enzymes E={e₁, . . . , eⱼ}, and on a plurality of markers M={mₖ₁, . . . , mₖₗ}, performing a private set intersection cardinality (PSI-CA) procedure on a client set F_{C} and a server set F_{S}; and performing a learning procedure in the first input source (Client) to generate pt, where pt represents how many of the first input's genome fragments are the same size as the second input's genome fragments.

The method further includes the step of emulating a digestion process of each of the plurality of enzymes on each of the first and second inputs' genomes to produce a plurality of fragments.

The step of inputting the respective digitized genomes from first input source (Client) and second input source (Server) of further includes the step of selecting a plurality of fragments {frag₁, . . . , fragₗ} corresponding to the plurality of markers for each of the respective digitized genomes from first input source (Client) and second input source (Server).

The step of inputting the respective digitized genomes of the first input source (Client) and second input source (Server) includes building the client set F_{C}={(|fragᵢ₍^{c))}|, mkᵢ₎}^{I}ᵢ₌₁ from the first input source (Client) and building the server set F_{S}={(|fragᵢ^{(s)}|, mkᵢ)}^{I}ᵢ₌₁ from the second input source (Server); and further includes replacing each marker M not corresponding to any fragment fragᵢ^{(c)} of the first input with an empty string.

The method further includes the step of comparing pt to the threshold τ in the first input source (Client) to learn the result of the privacy-preserving genetic paternity testing for determining if a biological relationship exists between the respective digitized genomes of the first input source (Client) and second input source (Server).

The method further includes preventing the second input source (Server) from learning pt, where pt represents how many of the first input's (Client) genome fragments are the same size as the second input's (Server) genome fragments.

The illustrated embodiments also contemplate a method for performing a privacy-preserving personalized medicine test in silico for determining if respective digitized genomes communicated from a second input source (Server) is a genetic match to a genetic fingerprint fp prepared by a first input source (Client) including the steps of performing an offline stage of an Authorized Private Set Intersection procedure (APSI) based protocol on its genome G in the second input source (Server), performing an online stage of the APSI protocol procedure on the fingerprint fp and the genome G, respectively in the first input source (Client) and the second input source (Server), obtaining the results of the online stage of the APSI protocol procedure in the first input source (Client), and determining if there is a match for the fingerprint fp in the second input source (Server).

The method further includes the step of authorizing the fingerprint fp by an authorization authority (CA).

The step of authorizing the fingerprint fp by an authorization authority (CA) includes authorizing a the genetic fingerprint fp corresponding to a pharmaceutical drug.

The method further includes the step of preventing the authorization authority (CA) from learning if there is a match for the fingerprint fp in the second input source (Server).

The illustrated embodiments also include within their scope a method for performing a privacy-preserving genetic compatibility test in silico between a first input source (Client) and a second input source (Server) including the steps of inputting a genetic fingerprint of a genetic disease \hat{D} into the first input source (Client), inputting a fully-sequence genome G into the second input source (Server), performing a Private Set Intersection (PSI) based protocol procedure over the fingerprint for genetic disease \hat{D} and genome G, respectively in the first input source (Client) and second input source (Server) and learning in the first input source (Client) whether or not the second input source (Server) carries the genetic disease \hat{D} in the fully-sequence genome G.

The step of learning in the first input source (Client) whether or not the second input source (Server) carries the genetic disease \hat{D} in the fully-sequence genome G includes the step of learning in the first input source (Client) if the genome G of the second input source (Server) carries the entire fingerprint of the genetic disease \hat{D}.

The step of learning in the first input source (Client) whether or not the second input source (Server) carries the genetic disease \hat{D} in the fully-sequence genome G includes the step of learning in the first input source (Client) if the genome G of the second input source (Server) carries a pre-determined subset of nucleotides of the fingerprint of the genetic disease \hat{D}.

The method further includes the step of preventing the second input source (Server) from learning if the genome G carries the genetic disease \hat{D}.

The method further includes the step of preventing the first input source (Client) from learning any part of the second input source's (Server) genome G, other than if it carries the genetic disease \hat{D}.

The method further includes the step of preventing the first input source (Client), second input source (Server), and/or a third input source (CA) from learning the results of the genomic testing learned by the other input sources present.

The embodiments of the invention further include a system for performing privacy-preserving genetic paternity testing in silico over the full genome which includes in turn a first input source (Client), and a second input source (Server) where respective digitized genomes are input into the first input (Client) and second input (Server), where in each of the first input source (Client) and second input source (Server) are capable of performing a restriction fragment length polymorphism procedure (RFLP) based protocol on a common input of a threshold T, on a plurality of enzymes E={e₁, . . . , eⱼ}, and on a plurality of markers M={mₖ₁, . . . , mₖⱼ}, where a private set intersection cardinality (PSI-CA) procedure is capable of being performed on a client set F_{C} and a server set F_{S} in the respective input sources; and where a learning procedure is capable of being performed in the first input source (Client) to generate pt, where pt represents how many of the first input's genome fragments are the same size as the second input's genome fragments.

The first input source (Client) and the second input source (Server) are capable of emulating a digestion process of each of the plurality of enzymes on each of the first and second inputs' genomes to produce a plurality of fragments, selecting a plurality of fragments {frag₁, . . . , fragₗ} corresponding to the plurality of markers for each of the respective digitized genomes from first input source (Client) and second input source (Server), where the first input source (Client) is capable of building the client set F_{C}={(|fragᵢ₍^{c))}|, mkᵢ₎}^{I}ᵢ₌₁ where the second input source (Server) is capable of building the server set Fₛ={(|fragᵢ^{(s)}|, mkᵢ)}^{I}ᵢ₌₁ and replacing each marker M not corresponding to any fragment fragᵢ^{(c)} of the first input with an empty string.

The first input source (Client) is capable of comparing pt to the threshold τ to learn the result of the privacy-preserving genetic paternity testing for determining if a biological relationship exists between the respective digitized genomes of the first input source (Client) and second input source (Server).

The second input source (Server) is capable of being prevented from learning pt, where pt represents how many of the first input's (Client) genome fragments are the same size as the second input's (Server) genome fragments.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a table showing private set intersection cardinality (PSI-CA) construction, which offers the best solution to communication and computation complexities. Private set intersection cardinality is also used rather than private set instruction since participants only need to learn how similar their genomes are.

FIG. 2 is a table showing the PSI protocol with linear complexity secure against malicious adversaries.

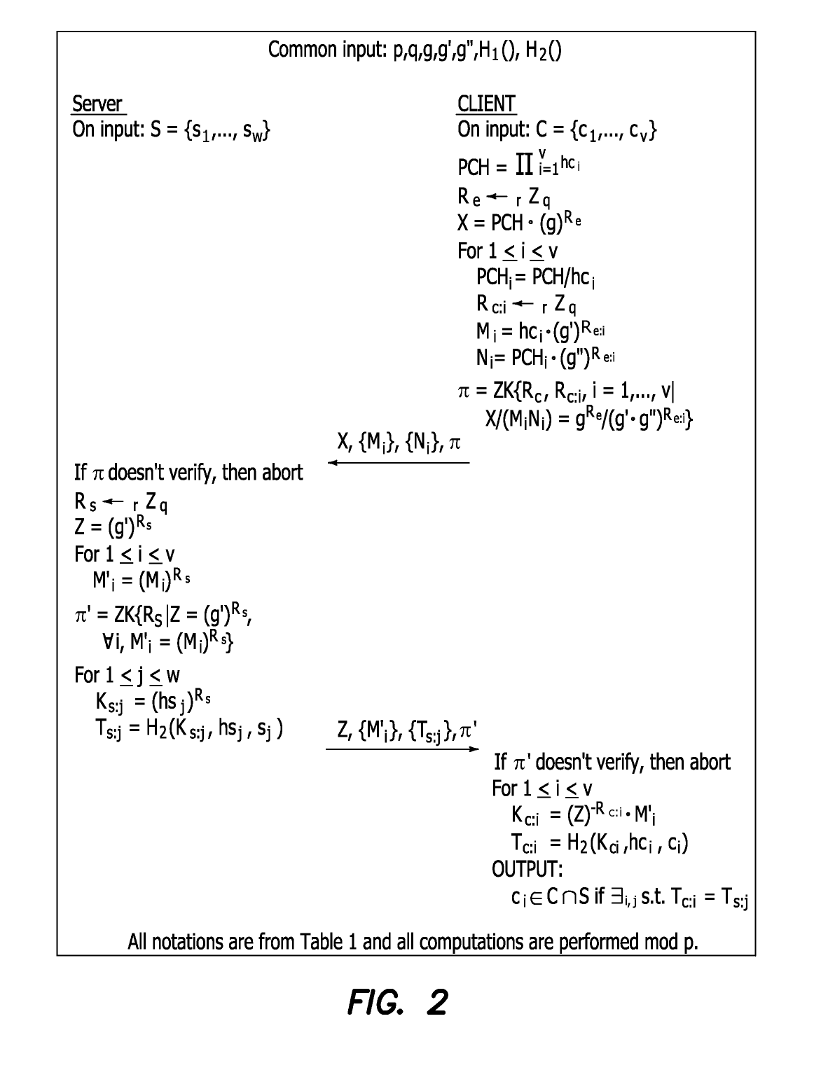

FIG. 3 is a table showing a comparison of our results to prior work on privacy-preserving paternity testing.

FIG. 4 is a table showing a specific prior art APSI construction, since it currently offers lowest communication and computation complexity.

FIG. 5 is a block diagram of one embodiment of the system of the invention.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DEFINITIONS

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the methods, devices, and materials are now described. All publications mentioned herein are incorporated herein by reference for the purpose of describing and disclosing the materials and methodologies which are reported in the publications which might be used in connection with the invention. Nothing herein is to be construed as an admission that the invention is not entitled to antedate such disclosure by virtue of prior invention.

Genomes represent the entirety of an organism's hereditary information. They are encoded either in DNA or, for many types of viruses, in RNA. The genome includes both the genes and the noncoding sequences of the DNA/RNA. For humans and many other organisms, the genome is encoded in double stranded deoxyribonucleic acid (DNA) molecules, consisting of two long and complementary polymer chains of four simple units called nucleotides, represented by the letters A, C, G, and T. The human genome consists of approximately 3 billion letters.

Restriction Fragment Length Polymorphisms (RFLPs) refers to a difference between samples of homologous DNA molecules that come from differing locations of restriction enzyme sites, and to a related laboratory technique by which these segments can be illustrated. In RFLP analysis, a DNA sample is broken into pieces (digested) by restriction enzymes and the resulting restriction fragments are separated according to their lengths by gel electrophoresis. Thus, RFLP provides information about the length (but not the composition) of DNA subsequences occurring between known subsequences recognized by particular enzymes. Although it is being progressively superseded by inexpensive DNA sequencing technologies, RFLP analysis was the first DNA profiling technique inexpensive enough for widespread application. It is still widely used at present. RFLP probes are frequently used in genome mapping and in variation analysis, such genotyping, forensics, paternity tests and hereditary disease diagnostics.

Single Nucleotide Polymorphisms (SNPs) are the most common form of DNA variation occurring when a single nucleotide (A, C, G, or T) differs between members of the same species or paired chromosomes of an individual. The average SNP frequency in the human genome is approximately 1 per 1,000 nucleotide pairs. SNP variations are often associated with how individuals develop diseases and respond to pathogens, chemicals, drugs, vaccines, and other agents. Thus SNPs are key enablers in realizing personalized medicine. Moreover, they are used in genetic disease and disorder testing, as well as to compare genome regions between cohorts in genome-wide association studies.

Short Tandem Repeats (STRs) occur when a pattern of two or more nucleotides are repeated and repeated sequences are directly adjacent to each other. The pattern can range in length from 2 to 50 nucleotides or so. Unrelated people likely have different numbers of repeat units in highly polymorphic regions, hence, STRs are often used to differentiate between individuals. STR loci (i.e., locations on a chromosome) are targeted with sequence-specific primers. Resulting DNA fragments are then separated and detected using electrophoresis. By identifying repeats of a specific sequence at specific locations in the genome, it is possible to create a genetic profile of an individual. There are currently over 10,000 published STR sequences in the human genome.

Private Set Intersection (PSI): a protocol between Server with input S={s₁, . . . , s_{w}}, and Client with input C={c₁, . . . , cᵥ}. At the end, Client learns S∩C. private set instruction securely implements: F_{PSI}: (S,C)→(⊥, S∩C).

Private Set Intersection Cardinality (PSI-CA): a protocol between Server with input S={s₁, . . . , s_{w}}, and Client with input C={C₁, . . . , cᵥ}. At the end, Client learns |S∩C|. PSI-CA securely implements: F_{PSI-CA}: (S,C)→(⊥, |S∩C|).

Authorized Private Set Intersection (APSI): a protocol between Server with input S={s₁, . . . , s_{w}}, and Client with input C={c₁, . . . , cᵥ} and C_{σ}={σ₁, . . . , σᵥ}. At the end, Client learns: ASI=S∩{cᵢ|cᵢεCΛσᵢ valid auth. on cᵢ}. APSI securely implements: F_{APSI}: (S, (C,C_{σ}))→(⊥, ASI).

Adversarial Model. We use standard security models for secure two-party computation. One distinguishing factor is the adversarial model that is either semi-honest or malicious. (For clarity in this application, the term adversary refers to insiders, i.e., protocol participants. Outside adversaries are not considered, since their actions can be mitigated via standard network security techniques).

Protocols secure in the presence of semi-honest adversaries assume that parties faithfully follow all protocol specifications and do not misrepresent any information related to their inputs, e.g., size and content. However, during or after protocol execution, any party might (passively) attempt to infer additional information about the other party's input. This model is formalized by considering an ideal implementation where a trusted third party (TTP) receives the inputs of both parties and outputs the result of the defined function. Security in the presence of semihonest adversaries requires that, in the real implementation of the protocol (without a TTP), each party does not learn more information than in the ideal implementation.

Security in the presence of malicious parties allows arbitrary deviations from the protocol. However, it does not prevent parties from refusing to participate in the protocol, modifying their inputs, or prematurely aborting the protocol. Security in the malicious model is achieved if the adversary (interacting in the real protocol, without the TTP) can learn no more information than it could in the ideal scenario. In other words, a secure protocol emulates (in its real execution) the ideal execution that includes a TTP. This notion is formulated by requiring the existence of adversaries in the ideal execution model that can simulate adversarial behavior in the real execution model.

Although security arguments within the illustrated embodiment of the invention are made with respect to semi-honest participants, extensions to malicious participant security (with the same computation and communication complexities) have already been developed for our cryptographic building blocks: PSI, PSI-CA and APSI.

### DETAILED DESCRIPTION OF THE PREFERRED EMBODIMENTS

We assume that each participant has a digital copy of her fully sequenced genome denoted by G={(b₁∥1), . . . , (bₙ∥n)}, where bᵢε{A, G, C, T, −}, n is the human genome length (i.e., 3×10⁹), and “∥” denotes concatenation. The “−” symbol is needed to handle DNA mutations corresponding to deletion, i.e., where a portion of a chromosome is missing. It is also used when the sequencing process fails to determine a nucleotide. This data may be pre-processed in order to speed up execution of specific applications.

For example, parties may pre-compute a cryptographic hash, H(·) on each nucleotide, alongside its position in the genome, i.e., for each (bᵢ∥i)εG, they compute hbᵢ=H(bᵢ∥i)³.

We use the notation |str| to denote the length of string str, and |A| to denote the cardinality of set A. Finally, we use r←R to indicate that r is chosen uniformly at random from set R.

Unless explicitly stated otherwise, all experiments were performed on a Linux Desktop, with an Intel Core i5-560M (running at 2.66 GHz). All tests were run on a single processor core and all code is written in C, using OpenSSL and GMP libraries. Cryptographic protocols use the SHA-1 hash function and 1024-bit moduli.

A Genetic Paternity Test (GPT) allows two individuals with their respective genomes to determine whether there exists a biological parent-child relationship between them. A Privacy-Preserving Genetic Paternity Test (PPGPT) achieves the same result without revealing any information about the two genomes. In the following, we refer to the two participants as Client and Server. Only Client receives the outcome of the test.

Strawman Approach

Genomics studies have shown that about 99.5% of any two human genomes are identical. Humans carry two copies of each chromosome, inherited one from the mother and one from the father. Thus, genomes carried by two individuals tied by a parent-child relationship show an even higher degree of similarity. As a result, one immediate computational technique for GPT is to compare the candidate's genome with that of the child; the test returns a positive result if the percentage of matching nucleotides is above a given threshold τ, i.e., significantly higher than 99.5%.

At first glance, protecting privacy is relatively easy: recent proposals for Private Set Intersection Cardinality (PSI-CA) protocols offer efficient and private two party computation of the number of set elements shared by two parties. Thus, to perform privacy preserving genetic paternity testing, two participants just need to run PSI-CA on input of their respective genomes.

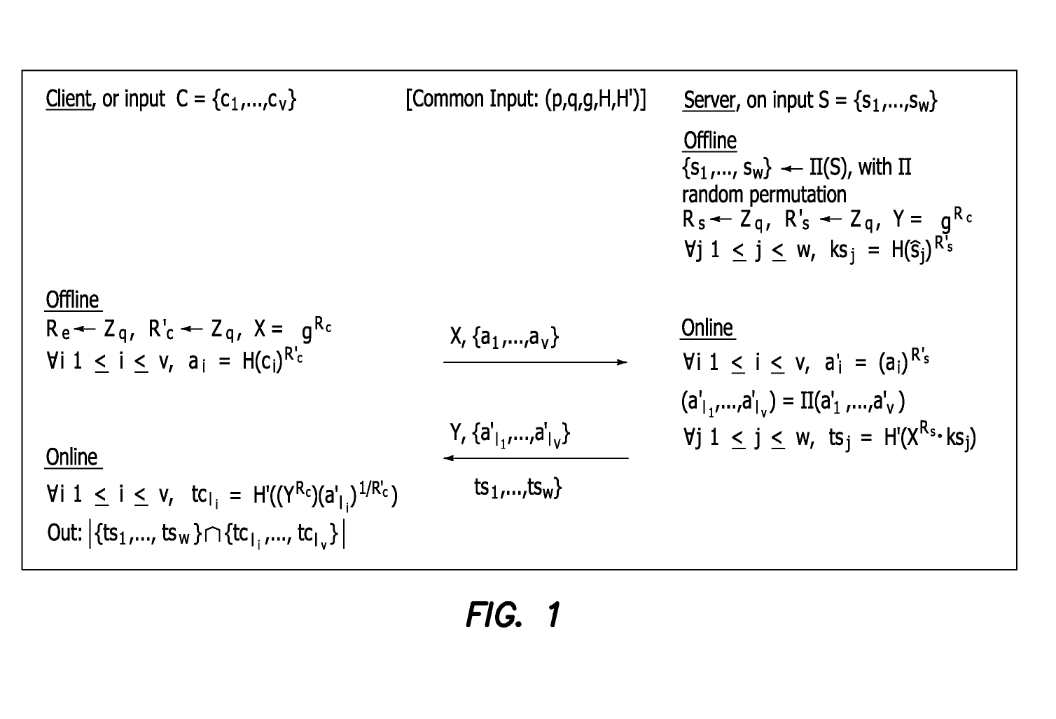

We select the PSI-CA construction, shown in FIG. 1, since it offers the best communication and computation complexities. Also, we use PSI-CA rather than private set instruction since semi-honest participants only need to learn how similar their genomes are. Whereas, PSI would also reveal where the two genomes differ and/or where they have common features.

We emphasize that this approach provides very accurate results, and is not significantly affected by potential sequencing errors. In fact, given expected error ratio ε, one can simply modify threshold τ to accommodate errors. This is because ε is expected to be significantly smaller than the difference between τ and the percentage of nucleotides that any two individuals share.

Unfortunately, since the number of nucleotides in the human genome is extremely large (about 3×10⁹), this technique, though optimal in terms of accuracy, is impractical using current commodity hardware, as it requires both parties to perform online computation over the entire genome. Specifically, PSI-CA entails a number of (short) modular exponentiations linear in the input size. Table 1 estimates execution times and bandwidth incurred by this naive approach. Since Client's online computation depends on that of the Server, a single test would consume approximately 10 days.

TABLE 1

| | |
|---|---|
| Offline | Online |

| | Time | Time | Size |
|---|---|---|---|
| Client | 4.5 days | 4.5 days | 358 GB |
| Server | 4.5 days | 4.5 days | 414 GB |

Since about 99.5% of the human genome is the same, two parties would only need to compare the remaining 0.5%. Unfortunately, there is yet not enough statistical knowledge to pinpoint where exactly this 0.5% occurs. Nonetheless, experts claim that, in practice, comparing a properly chosen 1% of the genome yields an accuracy comparable to analyzing the entire genome. Running times and bandwidth overhead required by this improved method are presented in Table 2.

TABLE 2

| | |
|---|---|
| Offline | Online |

| | Time | Time | Size |
|---|---|---|---|
| Client | 67 mins | 67 mins | 3.57 GB |
| Server | 67 mins | 67 mins | 4.14 GB |

In a first embodiment, a very efficient technique for Privacy preserving genetic paternity testing (PPGPT) is presented. To construct it, we take advantage of domain knowledge in genomics and build upon effective in vitro techniques (RFLP or SNP) rather than generic computational techniques. First, we design a protocol that implements RFLP based GPT. Next, we propose a cryptographic technique for secure computation of this protocol that realizes privacy preserving genetic paternity testing. Finally, we show that the technique used for computing RFLP-based GPT can be easily adapted to perform SNP-based GPT.

As discussed above, RFLPs use specific restriction enzymes (e.g., HaeIII, PstI, and HinfI), to digest a genome into hundreds of smaller fragments. Following the deterministic and well-known process, enzymes cut the DNA at each occurrence of a given pattern (e.g., “CTGCAG” with PstI). Next, a subset of these fragments is selected using a small number of probes for well-known markers, which are located in known areas of the genome. In an RFLP based paternity test, this process is applied to the DNA of the two tested individuals. If resulting fragments have comparable lengths, then the test returns a positive with certain confidence, based on the exact number of fragments of the same length.

There are a few slightly different ways to select the type and the number of markers, thus identifying exactly which fragments to compare. For the sake of reliability, one needs to use markers that are rare enough (i.e., occur in unrelated individuals with very low probability) while common enough to occur in at least one of the tested subjects. Currently, public databases and scientific literature offer thousands available probes for RFLP in human genomes. However, to reduce the cost of in vitro tests, only a small subset of them is actually used. Different laboratories consider various accuracy/cost trade-offs. Some compare as few as 9-15 DNA markers, returning a positive result whenever fewer than two fragments do not match, with an estimated 99.9% accuracy. Meanwhile, others use up to 25 markers and return a positive whenever fewer than two fragments do not match, thus providing significantly higher accuracy, i.e., about 99.999%.

In the United States, these testing methodologies follow precise regulations issued by the American Association of Blood Banks (AABB) and are considered legally admissible as evidence in the court of law. Since our privacy preserving technique closely mimics the in vitro procedure, it achieves the same level of accuracy. Nevertheless, as the cost of RFLP emulation on digitalized genomes is not significantly affected by the number of selected markers, we can anticipate increasing the number of markers to improve accuracy. We could perform tests with 50 markers and show that this only adds a small cost. Selection of additional markers may also be used since their introduction does not change the algorithm's functionality presented below.

RFLP-based Protocol. This protocol involves two individuals, on private input of their respective fully sequenced genomes. We distinguish between Client and Server, to denote the fact that only the former learns the test outcome. The protocol is run on common input of: a threshold τ, a set of enzymes E={e₁, . . . , eⱼ}, and a set of markers M={mₖ₁, . . . , mₖₗ}. Each participant also inputs its digitized genome.

First, participants emulate the digestion process of each enzyme eᵢεE on their genome. Consider, for instance, the PstI enzyme: whenever the string CTGCAG occurs, the enzyme cuts the genome in two fragments, so that the first ends with CTGCA and the second starts with G. As a result, genomes are digested into a large number of fragments of variable length.

Next, participants probe the fragments using markers in M. During this process, each participant selects up to fragments {frag₁, . . . , frag_{I}} (e.g., I=25), corresponding to M. All remaining fragments are discarded. Public markers are chosen such that each appears in at most one sequence.

The Client builds the set F_{C}={(|fragᵢ^{(c)})|, mkᵢ)}^{I}ᵢ₌₁. For each marker i not corresponding to any fragment, fragᵢ^{(c)} is replaced with the empty string. Similarly, Server builds Fₛ={(|fragᵢ^{(s)}|, mkᵢ)}^{I}ᵢ₌₁.

Next, Client and Server run the PSI-CA protocol described in FIG. 1, on respective inputs: F_{C} and F_{S}. Client learns pt=|F_{C}∩F_{S}|, i.e., how many of its and Server's fragments are of the same size.

Finally, Client learns the test result by comparing pt to threshold T.

It might seem that comparing string lengths is unreliable since two same-length strings might encode completely different content, while the current protocol would consider these strings as matching. In practice, however, this well-established technique yields false positives with extremely low probability. Sequences are selected using markers, i.e., according to (part of) their content. Selection of markers, in turn, guarantees that they appear only in one specific position in the entire genome. Edges of each fragment are content-dependent as well, since enzymes digest them according to a specific pattern of nucleotides. Therefore, two unrelated sequences of the same length would not be compared and two same-length sequences containing the same marker should be indeed considered matching.

Furthermore, this approach boosts the resilience of privacy preserving genetic paternity testing against sequencing errors. Only errors occurring in the pattern digested by enzymes (or in the markers) influence the result of the RFLP-based privacy preserving genetic paternity testing. However, since patterns and markers are relatively short compared to the size of the genome, this happens with very low probability, since sampling errors are uniformly distributed. However, if we let participants compare hashes of fragments, rather than their length, even a moderate error rate would severely increase the probability of false negatives, since even a single sequencing error would affect the final outcome of the test. Moreover, the main purpose of the privacy preserving genetic paternity testing presented herein is not to improve accuracy of the in vitro test currently used, but to efficiently and securely replicate it in silica

The use of PSI-CA, rather than private set instruction, is needed to minimize information learned by Client from protocol execution. With PSI, if the number of matches is sufficiently high (even if the test is negative), Client would learn the lengths of several Server's fragments: it could then use this information to perform a paternity test between the party previously playing the role of Server and any other individual (although with slightly lower reliability).

SNP-based tests are replacing RFLP-based tests due to their better performance. While this technique is not yet considered legally admissible in court, it is expected to eventually supersede its RFLP-based counterpart. The current RFLP-based protocol can be extended to perform paternity testing using SNPs: instead of selecting fragments using enzymes and markers, the SNP-based test selects fragments using a set of known SNPs. Since the rest of the protocol is unchanged and the size of the set of SNPs is usually 52 elements, the new protocol performs almost identically to the RFLP-based privacy preserving genetic paternity testing protocol with 50 fragments.

The performance of the RFLP-based protocol on the Intel Core i5-560M testbed can be measured. The (offline) time needed to emulate the enzyme digestion process on the full genome is 74 seconds. This computation is performed only once, thus, it does not affect the time required to perform the interactive protocol. Finally, in order to assess the practicality of the protocol on embedded devices, we also measured its performance on a modern smart phone, for example, a Nokia N900 equipped with ARM

Cortex A8 CPU running at 600 MHz. Table 3 below summarizes the online cost of the RFLP-based protocol, measuring computation and communication overhead, using different numbers of markers, on both i5-560M and A8 processors.

TABLE 3

| | Offline (Time) | | Online (Time/size) | | |
|---|---|---|---|---|---|
| Entity (markers) | i5-560M | A8 | i5-560M | A8 | Size |
| Client (25) | 3.4 ms | 323 ms | 3.4 ms | 323 ms | 3 KB |
| Server (25) | 3.4 ms | 323 ms | 3.4 ms | 323 ms | 3.5 KB |
| Client (50) | 6.7 ms | 645 ms | 6.7 ms | 645 ms | 6 KB |
| Server (50) | 6.7 ms | 645 ms | 6.7 ms | 645 ms | 7 KB |

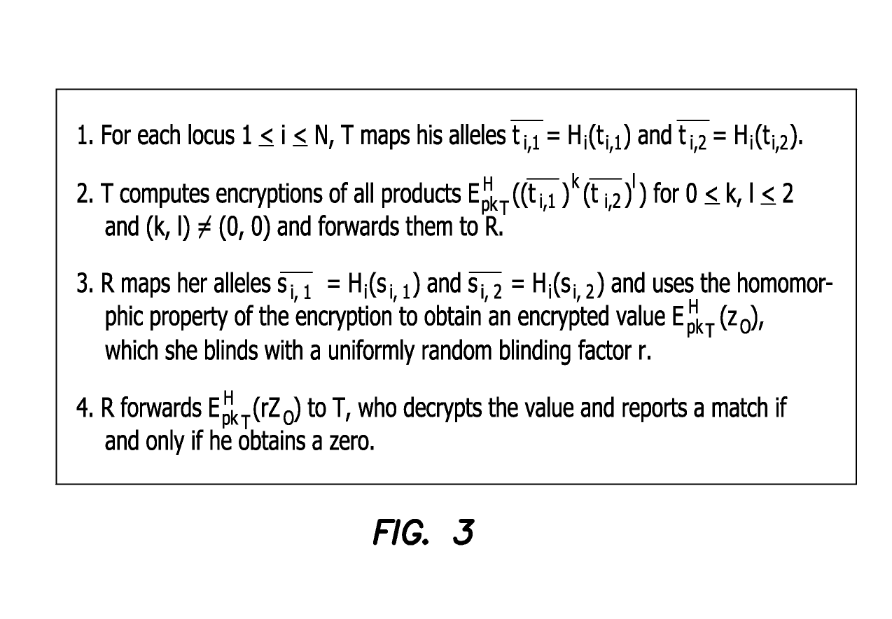

For the sake of completeness, we compared our results to prior work on privacy-preserving paternity testing, specifically that which is seen in FIG. 3. Following a conservative approach, we instantiate: (i) the cheapest protocol variant, which tolerates no error, and (ii) the most efficient additively homomorphic cryptosystem among those suggested, i.e., modified ElGamal. Also, we only count the number of modular exponentiations. Given that the paternity test is performed over n alleles (with n ranging from 13 to 67 for increasing accuracy) we estimate the following costs. In step (2) of the protocol, the party obtaining the test result computes 8n modified ElGamal encryptions, thus, incurring 24n (short) modular exponentiations. In the i5-560M testbed, this takes from 43 ms to 224 ms, depending on n. In step (3), the other party needs to obtain the encrypted sum using homomorphic properties: it does so by performing 30n exponentiations. This takes between 54 and 262 ms on the i5-560M testbed. Even ignoring all other operations and without pre-computation, our most accurate test (using 50 markers) is about 5 times faster than the least accurate test which uses 13 alleles.

In another embodiment, the current protocol is used in the field of personalized medicine. Personalized Medicine (PM) is increasingly used to provide patients with drugs designed for their specific genetic features. As discussed above, in the context of PM, drugs are associated with a unique genetic fingerprint. Their effectiveness is maximized in patients with a matching DNA. To this end, genomes need to be compared against the fingerprint and a patient needs to surrender her DNA to a physician or a pharmaceutical company.

One privacy-preserving approach is to let the patient independently run specialized software over her genome and identify a match (or lack thereof) with a given drug's fingerprint. This way, the patient would learn whether the drug is appropriate. However, pharmaceuticals may consider DNA fingerprints of their drugs to be trade secrets and thus might be unwilling to reveal them. At the same time, for every new drug, pharmaceuticals are required to obtain approval from appropriate government entities, e.g., the Food and Drug Administration (FDA) in case of the United States.

The current technique for Privacy-Preserving Personalized Medicine Testing (P³MT), comprises the following steps:
Following positive clinical trials, a pharmaceutical company obtains FDA approval on a specific DNA fingerprint fp and receives a corresponding authorization, auth.
The pharmaceutical and the patient engage in a protocol, where the former inputs (fp, auth) and the latter inputs her genome.
At the end of the protocol, the pharmaceutical learns whether the patient's genome matches fingerprint fp, provided that auth is a valid authorization of fp.

Privacy requirements are that: (1) the company learns nothing about patient genome besides the part matching the (authorized) fingerprint, and (2) the patient learns nothing about fp or auth.

In a specific embodiment, using PRIVACY-PRESERVING PERSONALIZED MEDICINE TESTING instantiation comprises: (1) an authorization authority (e.g., the FDA) denoted as CA, (2) a pharmaceutical-Client, and (3) a patient-Server.

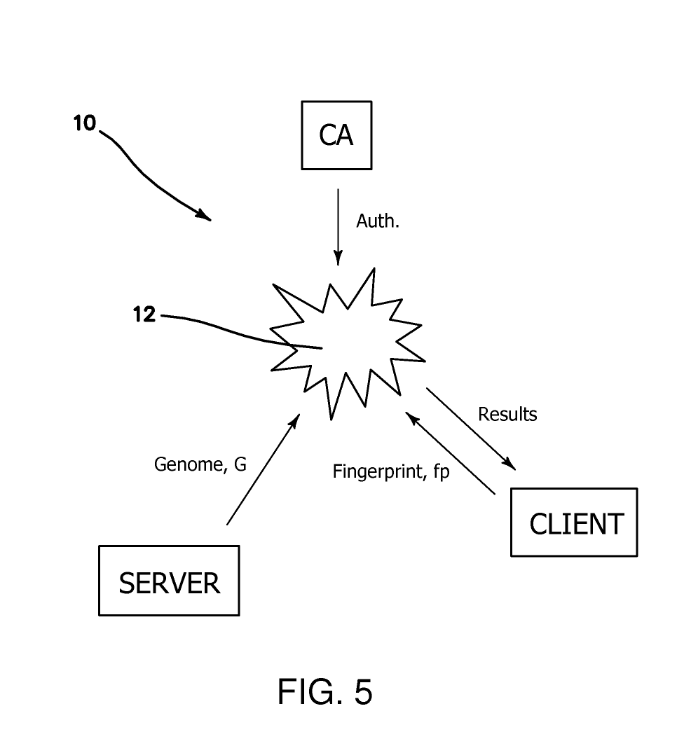

The embodiment is performed by the system 10 as seen in FIG. 5 in block diagram form. Here, the Client, Sever, and authorization authority CA are connected to one another via a network 12. The network 12 may be an internal communication network or an external or wireless communication network such as the internet. As detailed further below, the Client provides or uploads to the network 12 a genetic fingerprint fp relating to a specific drug. Similarly, the Server provides the network 12 with their specific genome G. Finally, the authorization authority CA provides the network 12 with appropriate authorization or parameters so that the scope of the test is limited, for example, to the appropriate set of required nucleotides over the Server's genome. After performing the test, the network 12 relays the results back to the Client, thus ensuring only the Client learns whether the Server is an appropriate match to the uploaded fingerprint fp. The Client, Server, and authorization authority CA may be any known source of data input such as a computer or computer network or a personal electronics device such as a tablet or smart phone.

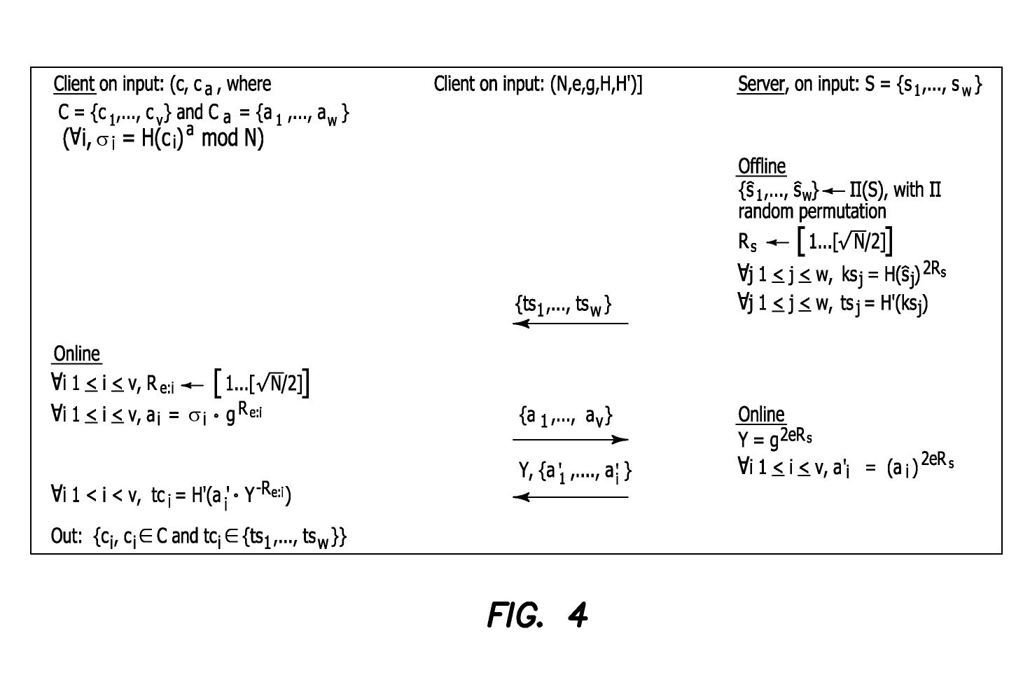

Our cryptographic building block is Authorized Private Set Intersection (APSI), hence, our Client/Server/CA notation. We begin by selecting one specific APSI construction already known seen in FIG. 4, since it currently offers lowest communication and computation complexity. (Moreover, it can be instantiated in the malicious model with only a small constant additional overhead.) For efficiency reasons, R_{C:I}'s and R_{S} are chosen uniformly at random from W=[1 . . . |√N/2|], rather than from Z_{N/2}, as in the original version of the protocol. In fact, the distribution of g^{x} mod N with x←W is computationally indistinguishable from the distribution defined by g^{x} with x←[1 . . . Φ(N)]. This change does not affect protocol security arguments. Thus, we do not provide a new proof for APSI in the current application.

PRIVACY-PRESERVING PERSONALIZED MEDICINE TESTING involves two phases: offline and an online.

During the offline phase:

1. CA generates RSA public-private keypair ((N,e), d), publishes (N, e), and keeps d private.

2. Client prepares a fingerprint of drug D: fp(D)={(bⱼ*∥j)}, where each bⱼ* is expected at position j of a genome suitable for D.

3. Client obtains from CA an authorization auth(fp(D)), where auth(fp(D))={σⱼ|σⱼ=H(bⱼ*∥j)^{d} mod N}.

4. Server runs the offline stage of the APSI protocol in FIG. 4, on input, G={(b₁∥1), . . . , (bₙ∥n)}, and publishes resulting {ts₁, . . . , tsₙ}.

During the online phase:

1. Client and Server run the online part of the APSI protocol in FIG. 4. Recall that Client's input is (fp(D), auth(fp(D))), and Server's is G.

2. After the interaction, Client obtains fp(D)∩G, and uses this information to determine whether Server is well-suited for drug D.

We note that auth is needed to limit the scope of the test on a patient DNA: the FDA can guarantee that: (i) fp only covers the appropriate set of required nucleotides, and (ii) pharmaceuticals cannot input arbitrary portions of a patient genome.

The proposed PRIVACY-PRESERVING PERSONALIZED MEDICINE TESTING protocol is resilient against (randomly distributed) sequencing errors. The size of the fingerprint input by Client in the protocol is negligible compared to the size of the entire genome. Thus, positions corresponding to Client input are affected by errors with extremely low probability.

To estimate the efficiency of the PRIVACY-PRESERVING PERSONALIZED MEDICINE TESTING protocol, we consider two genetic tests commonly performed in the context of personalized medicine: the analysis of hla-B and tpmt genes. Our choice is also motivated by the size of their fingerprints that, according to genomics experts, is representative of most personalized medicine tests.

First, we look at the hla-B*5701 allelic variant, one G→1 mutation associated with extreme sensitivity to abacavir, a drug used in HIV treatment. In diploid organisms (such as humans), mutation may occur in either chromosome inherited from the parents.

Thus, the related fingerprint contains 2 (nucleotide, position) pairs. We also consider the analysis of tpmt typically done before prescribing 6-mercaptopurine to leukemia patients. As is previously known, two alleles are known to cause the tpmt disorder: (1) one presents a mutation G→C in position 238 of gene's c-DNA, (2) the other presents one mutation G→A in position 460 and one A→G in position 719⁴. Therefore, the resulting fingerprint contains these 6 (nucleotide, position) pairs.

In the underlying APSI protocol (seen in FIG. 4), cryptographic operations on Server genome do not depend on Client input. Therefore, they can be computed offline, once for all possible tests. Moreover, we have designed the PRIVACY-PRESERVING PERSONALIZED MEDICINE TESTING protocol to be as generic as possible. Our protocol runs on the whole Server's genome—with linear complexity—in order to address future scenarios where genomics advances will cause better understanding of many more regions of human genomes. To reduce offline costs, we apply reference-based compression—a technique commonly used to efficiently represent genomic information. In particular, Server input consists of all differences between its genome and the reference sequence. We emphasize that this technique does not require any biological correctness of the reference genome that is only used for compression. This allows us to reduce the size of Server input to about 1% of the entire genome.

TABLE 4

| | |
|---|---|
| Offline | Online |

| Test | Party | Time | Time | Size |
|---|---|---|---|---|
| hla-b*5701 | Client | — | 0.82 ms | 256 B |
| | Server | 206 mins | 0.82 ms | 4.14 GB |
| spmt | Client | — | 2.46 ms | 768 B |
| | Server | 206 mins | 2.46 ms | 4.14 GB |

Table 4 summarizes execution time and bandwidth costs of the PRIVACY-PRESERVING PERSONALIZED MEDICINE TESTING protocol used for testing hla-B and tpmt. These costs cannot be meaningfully compared to prior work, since, to the best of our knowledge, there is no other technique targeting privacy-preserving personalized medicine testing. Furthermore, as mentioned above, there are no current techniques that enforce fingerprint authorization by a trusted entity, such as the FDA. Also, prior work is essentially designed for operation on DNA snippets, and it is unclear how to efficiently adapt it to full genomes.

In another embodiment, the system may be used for Genetic Compatibility Testing (GCT) which can predict whether potential partners are at risk of conceiving a child with a recessive genetic disease. This occurs when both partners carry at least one gene affected by mutation, i.e., they are either asymptomatic carriers or actual disease sufferers. As in the Beta-Thalassemia example discussed above, asymptomatic carriers usually need to learn whether their potential partner is also a carrier of the same disease, since this would pose a serious risk to their potential off-spring.

To achieve genetic compatibility testing with privacy we introduce the concept of Privacy-Preserving Genetic Compatibility Testing (PPGCT) that allows participants to run GCT without disclosing to each other: (1) any other genomic information, and (2) which disease(s) they are carrying or being tested for.

Current biological know ledge of the human genome allows screening for a genetic disease associated with one SNP in a specific gene. In other words, most well-characterized genetic diseases are caused by a mutation in a single gene. However, we anticipate that, in the near future, researchers will develop tests for more complex diseases (e.g., diabetes or hypertension) involving multiple genes and multiple mutations. Therefore, we aim to design PPGCT techniques not limited to single-mutation diseases. Additional motivating examples for PPGCT include compatibility testing for sperm and organ donors.

The proposed PPGCT protocol involves two participants: Client and Server. Client runs on input of a fingerprint of a genetic disease \hat{D}. Server runs on input of its fully-sequenced genome G. At the end of the interaction, Client learns the output of the test, i.e., whether Server carries disease \hat{D}.

Our cryptographic building block is Private Set Intersection (PSI). We select a known specific private set instruction construction best suited for communication and computation complexity. It can also be instantiated in the malicious model with only a small constant additional overhead. The PPGCT protocol involves the following steps:

1. Client builds a fingerprint corresponding to her genetic diseases fp(\hat{D})={(bⱼ*∥j)}, where each bⱼ* is expected at position j of a genome with disease \hat{D}.

2. Client and Server run the private set instruction protocol shown in FIG. 4 on respective inputs: fp(\hat{D}) and G.

3. Client obtains fp(\hat{D})∩G, and uses this information to determine whether Server carries disease \hat{D}.

The change from PSI-CA to PSI is motivated as follows. Depending on the disease being tested, a positive outcome occurs if the genome contains either: (1) the entire disease fingerprint, or (2) a given subset of nucleotides. In case of (1), the test result is positive only if: fp(\hat{D})C G, i.e., fp(\hat{D})∩G=fp(\hat{D}): if this happens, there is actually no difference between the output of private set instruction and that of PSI-CA. However, PSI-CA is preferred over private set instruction since, if the test is negative, less information about Server genome is revealed to Client. In case of (2), cardinality of set intersection is insufficient to assess the test result, since Client needs to learn which fingerprint nucleotides appear in Server's genome.

Similar to its P³Mf counterpart, the PPGCT protocol is resilient to uniformly distributed errors. In particular, since input size of Client is small, corresponding positions in Server genome are affected by errors with very low probability.

Unfortunately, a malicious Client could potentially harvest Server's genetic information (in addition to that needed for the compatibility test) by inflating its input. For instance, a healthy Client could learn whether or not Server carries a given genetic disease, unrelated to the compatibility testing.

As concrete examples, we use genetic compatibility tests for two genetic disorders: Roberts syndrome and Beta-Thalassemia. We chose them since they are fairly common and the size of their fingerprints is representative of that in most genetic compatibility tests.

Similar to PRIVACY-PRESERVING PERSONALIZED MEDICINE TESTING, we stress that cryptographic operations performed on Server genome, in the underlying private set instruction protocol, do not depend on Client input. Therefore, these operations can be pre-computed (just once) ahead of time.

First, we consider testing for Roberts syndrome, an autosomal genetic disorder, characterized by pre- and post-natal growth deficiency, limb malformations, and distinctive skull and facial abnormalities. As known in the art, there are 26 single point mutations (in the esco2 gene) causing this syndrome. Since humans are diploid organisms, we expect Roberts syndrome fingerprint to contain about 52 (nucleotide, location) pairs.

Next, we turn to Beta-Thalassemia. As is known in the art, more than 250 mutations in the hbb gene have been found to cause this disorder and most of them involve a change in a single nucleotide. Although reliable techniques to perform this test in silico are not yet available, it is reasonable to assume that the size of the Beta-Thalassemia fingerprint would include 2×250=500 (nucleotide, location) pairs.

Table 5 below summarizes run time (computational) and bandwidth requirements for the PPGCT protocol for Roberts syndrome and Beta-Thalassemia, respectively. Following the same arguments as in PRIVACY-PRESERVING PERSONALIZED MEDICINE TESTING experiments, we let Server input the portion of its genome that differs from the reference genome, i.e., about 1%.

TABLE 5

| | |
|---|---|
| Offline | Online |

| Test | Party | Time | Time | Size |
|---|---|---|---|---|
| Roberts syndrome | Client | — | 7.26 ms | 62.5 KB |
| | Server | 67 mins | 7.26 ms | 4.14 GB |
| Beta-Thalassemia | Client | — | 70 ms | 6.5 KB |
| | Server | 67 mins | 70 ms | 4.14 GB |

Performance of the PPGCT protocol cannot be meaningfully compared to prior work. As discussed above, it is not trivial to adapt current secure pattern matching techniques to genetic compatibility testing on fully sequenced genomes. An experimental study (including the adaptation of such techniques) is left for future work.

We now discuss security properties of protocols present within the invention. In general, security of each protocol is based on that of the underlying building blocks.

Also, out cryptographic building blocks (PSICA, APSI, and PSI) can be generally used in a black-box manner. One can select any instantiation without affecting security of our protocols, as long as the chosen construction yields secure PSI/APSI/PSI-CA functionality. However, we pick specific instantiations to maximize protocol efficiency. As discussed earlier, we consider semi-honest adversaries (participants). Nevertheless, we are not restricted to this model, since our cryptographic building blocks are (provably) adaptable to the malicious participant model, incurring a small constant extra overhead.

We now show that RFLP-based Genetic Paternity Testing (PPGPT) protocol embodiment discussed above is secure against semi-honest adversaries. We assume that PSI-CA performs secure computation of the FPsi·CA functionality, in the presence of semi-honest participants. We select a construction that is secure under the One-More-DH assumption in the Random Oracle Model (ROM).

We divide the protocol in two phases. In the first, both Client and Server privately and independently perform the RFLP-related computation on their respective inputs. (This covers steps 1 to 3 of PRIVACY PRESERVING GENETIC PATERNITY TESTING). At the end of this phase, Client and Server construct sets F_{C} and F_{S}, respectively. Clearly, during this phase, neither participant learns anything about the other's input. During the second phase (steps 4-5), participants use F_{C} and F_{C} as their respective inputs to PSI-CA. Given the security of the latter, Client only learns |F_{S}∩F_{C}|. PSI-CA protocols may reveal |F_{S}| to Client and |F_{C}| to Server. However, |F_{S}|=|F_{C}|=I, which is already known to both parties.

Similarly, security of the personalized medicine (P³MT) protocol embodiment against semi-honest Client and Server, stems from security of the underlying protocol—APSI. That is, if APSI performs secure computation of the F_{APSI} functionality in the presence of semi-honest participants, then PRIVACY-PRESERVING PERSONALIZED MEDICINE TESTING is also secure. This holds since a semi-honest participant with a non-negligible advantage in distinguishing between real and simulated executions of PRIVACY-PRESERVING PERSONALIZED MEDICINE TESTING would have the same advantage in distinguishing between real and simulated executions of APSI. Although one can use APSI as a black box, for efficiency reasons, we prefer instantiations that allow pre-computation on Server input. In our instantiation, we select an APSI construction that is proven secure under the RSA and DDH assumptions (in ROM).

Finally, security of the genetic compatibility testing (PPGCT) protocol embodiment discussed above against semi-honest adversaries relies on that of the underlying private set instruction protocol, to which it is immediately reducible. (In other words, a semi-honest participant with a non-negligible advantage in distinguishing between real and simulated executions of PPGCT would have the same advantage in distinguishing between real and simulated executions of private set instruction.) Again, although one can use private set instruction as a black box, for efficiency reasons, we need private set instruction instantiations that allow pre-computation on Server input, such as OPRF-based constructs. We chose a private set instruction from this is proven secure under the One-More-DH assumption (in ROM).

The illustrated embodiment of the invention identified and explored three popular privacy-sensitive genomic applications: (i) paternity tests, (ii) personalized medicine and (iii) genetic compatibility testing. Unlike most previous work, we focused on fully sequenced genomes. This scenario poses new challenges, both in terms of privacy and computational cost. For each application, we proposed an efficient construction, based on well-known cryptographic tools: Private Set Intersection (PSI), Private Set Intersection Cardinality (PSI-CA), and Authorized Private Set Intersection (APSI). Experiments show that these protocols incur online overhead sufficiently low to be practical today. In particular, the current protocol for privacy-preserving paternity testing is significantly less expensive—in both computation and communication—than prior work. Furthermore, all protocols presented herein have been carefully constructed to mimic the state-of-the-art of (in vitro) biological tests currently performed in hospitals and laboratories.

It should be expressly understood that the illustrated embodiment of the invention is also contemplated for use in other testing applications that may be useful or relevant in the future. These additional applications include, but are not limited to:
Introducing privacy-preserving genetic paternity testing based on STR and/or SNP comparison.
Exploring privacy-preserving techniques to realize genetic ancestry testing, i.e., to discover whether or not individuals are related up to a certain degree.
Extending the paternity test protocol to allow both participants to determine whether the other party introduced correct input according to some auxiliary authorization (Note that APSI does not suffice since one of the parties might alter its input so that the test is negative).
Investigation of additional privacy-sensitive applications for fully-sequenced genomes, such as certified forensic identification, where the subject of investigation must prove the authenticity of its input.
Privacy-preserving organ recipient's compatibility, where a subject efficiently identifies a matching sample without revealing information about her genome.
Extending the invention to include embodiments for the adaptation of secure pattern matching and text processing to personalized medicine and genetic compatibility testing on full genomes.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A method for performing privacy-preserving genetic paternity testing in silico over the full genome between a first input source (Client) and a second input source (Server) comprising:
inputting respective digitized genomes into the first input (Client) and second input (Server);
performing a restriction fragment length polymorphism procedure (RFLP) based protocol on a common input of a threshold τ, on a plurality of enzymes E={e₁, . . . , eⱼ}, and on a plurality of markers M={mₖ₁, . . . , mₖₗ};
performing a private set intersection cardinality (PSI-CA) procedure on a client set F_{C} and a server set F_{S}; and
performing a learning procedure in the first input source (Client) to generate pt, where pt represents how many of the first input's genome fragments are the same size as the second input's genome fragments.

2. The method of claim 1 further comprising emulating a digestion process of each of the plurality of enzymes on each of the first and second inputs' genomes to produce a plurality of fragments.

3. The method of claim 2 where inputting the respective digitized genomes from the first input source (Client) and the second input source (Server) further comprises selecting a plurality of fragments {frag₁, . . . , fragₗ} corresponding to the plurality of markers for each of the respective digitized genomes from first input source (Client) and second input source (Server).

4. The method of claim 1 where inputting the respective digitized genomes of the first input source (Client) and second input source (Server) comprises building the client set F_{C=}{(|fragᵢ₍^{c))}|, mkᵢ₎}^{I}ᵢ₌₁ from the first input source (Client) and building the server set Fₛ={(|fragᵢ^{(s)}|, mkᵢ)}^{I}ᵢ₌₁ from the second input source (Server); and
further comprising replacing each marker M not corresponding to any fragment fragᵢ^{(c)} of the first input with an empty string.

5. The method of claim 1 further comprising comparing pt to the threshold τ in the first input source (Client) to learn the result of the privacy-preserving genetic paternity testing for determining if a biological relationship exists between the respective digitized genomes of the first input source (Client) and second input source (Server).

6. The method of claim 1 further comprising preventing the second input source (Server) from learning pt, where pt represents how many of the first input's (Client) genome fragments are the same size as the second input's (Server) genome fragments.

7. A method for performing a privacy-preserving personalized medicine test in silico for determining if respective digitized genomes communicated from a second input source (Server) is a genetic match to a genetic fingerprint fp prepared by a first input source (Client) comprising:
performing an offline stage of an Authorized Private Set Intersection procedure (APSI) based protocol on its genome G in the second input source (Server);
performing an online stage of the APSI protocol procedure on the fingerprint fp and the genome G, respectively in the first input source (Client) and the second input source (Server);
obtaining the results of the online stage of the APSI protocol procedure in the first input source (Client); and
determining if there is a match for the fingerprint fp in the second input source (Server).

8. The method of claim 7 further comprising authorizing the fingerprint fp by an authorization authority (CA).

9. The method of claim 7 where authorizing the fingerprint fp by an authorization authority (CA) comprises authorizing the genetic fingerprint fp corresponding to a pharmaceutical drug.

10. The method of claim 8 further comprising preventing the authorization authority (CA) from learning if there is a match for the fingerprint fp in the second input source (Server).

11. A method for performing a privacy-preserving genetic compatibility test in silico between a first input source (Client) and a second input source (Server) comprising:
inputting a genetic fingerprint of a genetic disease \hat{D} into the first input source (Client);
inputting a fully-sequenced genome G into the second input source (Server);
performing a Private Set Intersection (PSI) based protocol procedure over the fingerprint for genetic disease \hat{D} and genome G, respectively in the first input source (Client) and second input source (Server); and
learning in the first input source (Client) whether or not the second input source (Server) carries the genetic disease \hat{D} in the fully-sequence genome G.

12. The method of claim 11 where learning in the first input source (Client) whether or not the second input source (Server) carries the genetic disease \hat{D} in the fully-sequence genome G comprises learning in the first input source (Client) if the genome G of the second input source (Server) carries the entire fingerprint of the genetic disease \hat{D}.

13. The method of claim 11 where learning in the first input source (Client) whether or not the second input source (Server) carries the genetic disease \hat{D} in the fully-sequence genome G comprises learning in the first input source (Client) if the genome G of the second input source (Server) carries a pre-determined subset of nucleotides of the fingerprint of the genetic disease \hat{D}.

14. The method of claim 11 further comprising preventing the second input source (Server) from learning if the genome G carries the genetic disease \hat{D}.

15. The method of claim 11 further comprising preventing the first input source (Client) from learning any part of the second input source's (Server) genome G, other than if it carries the genetic disease \hat{D}.

16. The method of claim 11 further comprising preventing the first input source (Client), second input source (Server), and/or a third input source (CA) from learning the results of the genomic testing learned by the other input sources present.

17. A system for performing privacy-preserving genetic paternity testing in silico over the full genome comprising:
a first input source (Client); and
a second input source (Server) where respective digitized genomes are input into the first input (Client) and second input (Server);
where in each of the first input source (Client) and second input source (Server) are capable of performing a restriction fragment length polymorphism procedure (RFLP) based protocol on a common input of a threshold τ, on a plurality of enzymes E={e₁, . . . , eⱼ}, and on a plurality of markers M={mₖ₁, . . . , mₖₗ}, where a private set intersection cardinality (PSI-CA) procedure is capable of being performed on a client set F_{C} and a server set F_{S} in the respective input sources; and where a learning procedure is capable of being performed in the first input source (Client) to generate pt, where pt represents how many of the first input's genome fragments are the same size as the second input's genome fragments.

18. The system of claim 17 where the first input source (Client) and the second input source (Server) are capable of emulating a digestion process of each of the plurality of enzymes on each of the first and second inputs' genomes to produce a plurality of fragments, selecting a plurality of fragments {frag₁, . . . , fragₗ} corresponding to the plurality of markers for each of the respective digitized genomes from first input source (Client) and second input source (Server), where the first input source (Client) is capable of building the client set F_{C}={(|fragᵢ₍^{c))}|, mkᵢ₎}^{I}ᵢ₌₁ where the second input source (Server) is capable of building the server set Fₛ={(|fragᵢ^{(s)}, mkᵢ)}^{I}ᵢ₌₁ and replacing each marker M not corresponding to any fragment fragᵢ^{(c)} of the first input with an empty string.

19. The system of claim 17 where the first input source (Client) is capable of comparing pt to the threshold τ to learn the result of the privacy-preserving genetic paternity testing for determining if a biological relationship exists between the respective digitized genomes of the first input source (Client) and second input source (Server).

20. The system of claim 17 where the second input source (Server) is capable of being prevented from learning pt, where pt represents how many of the first input's (Client) genome fragments are the same size as the second input's (Server) genome fragments.
